(19) United States
(12) Patent Application Publication
(10) Pub. No.: US 2026/0132279 A1
(43) Pub. Date: May 14, 2026

(54) EXTERIOR MATERIAL COMPOSITION FOR AUTOMOTIVE COMPRISING RECYCLED MATERIALS, AUTOMOTIVE EXTERIOR PARTS AND AUTOMOTIVE COMPRISING THE SAME

(71) Applicants: Hyundai Motor Company, Seoul (KR); Kia Corporation, Seoul (KR); HDC Hyundai Engineering Plastics Co., Ltd., Dangjin (KR)

(72) Inventors: Heejoon Lee, Hwaseong-si (KR); Kitae Kim, Hwaseong-si (KR); Minho Choi, Hwaseong-si (KR); Yong Wook Lee, Seongnam-si (KR); Chang Hee Kang, Seongnam-si (KR); Eun Seob Shin, Yongin-si (KR)

(73) Assignees: Hyundai Motor Company, Seoul (KR); Kia Corporation, Seoul (KR); HDC Hyundai Engineering Plastics Co., Ltd., Dangjin (KR)

(21) Appl. No.: 19/035,619

(22) Filed: Jan. 23, 2025

(30) Foreign Application Priority Data
Nov. 13, 2024 (KR) 10-2024-0160870

(51) Int. Cl. C08L 23/06; C08K 3/34

(52) U.S. Cl. CPC C08L 23/06; C08K 3/34; C08K 2201/005; C08L 2666/12; C08L 2666/58; C08L 2666/72

(57) ABSTRACT

The present disclosure relates to an exterior material composition for an automotive application, optionally including automotive exterior parts comprising the same, and more particularly, to an exterior material composition for an automotive application comprising a polyolefin-based recycled resin, high-density polyethylene (HDPE), an impact modifier, and a filler, automotive exterior parts comprising the same, and an automotive comprising the same.

### CROSS-REFERENCE TO RELATED APPLICATION

This present application claims the benefit of priority to Korean Patent Application No. 10-2024-0160870, filed on Nov. 13, 2024, in the Korean Intellectual Property Office, the entire disclosure of which is incorporated herein by reference in its entirety.

### FIELD

The present disclosure relates to an exterior material composition for an automotive application, optionally including automotive exterior parts comprising the same, and an automotive material comprising the same. In particular, the compositions described herein relate to an exterior material composition for an automotive application comprising a polyolefin-based recycled resin, high-density polyethylene (HDPE), an impact modifier, and a filler, optionally including automotive exterior parts comprising the same, and an automotive material comprising the same.

### BACKGROUND

In conventional automotive parts, key resins such as acrylonitrile-butadiene-styrene (ABS) copolymer, polycarbonate/polybutylene terephthalate (PC/PBT), and polyurethane have been predominantly utilized. However, with the growing emphasis on sustainability within the automotive sector, significant research and development efforts are now focused on enhancing the eco-friendliness of automotive interiors, components, and materials. Leading automotive manufacturers, both domestically and internationally, are exploring various avenues, including innovative materials and advanced processing techniques. As a result of these initiatives, many conventional resin components in automotive parts are increasingly being substituted with polyolefin-based resins, which offer advantages in terms of weight reduction, cost efficiency, and recyclability.

Polyolefins, recognized as exemplary recycled materials due to their eco-friendliness, find extensive applications across diverse sectors, including food packaging, textiles, automotive components, and various product packaging materials. Notable examples of polyolefins include polyethylene and polypropylene, which have garnered significant attention in recent research. In light of growing environmental concerns, numerous studies have been undertaken to explore the utilization of recycled polyolefin-based resins, focusing on their environmental impact and potential for sustainable development.

Despite their eco-friendly advantages, recycled polyolefins have disadvantages, including lower rigidity, reduced impact strength, and diminished mechanical properties compared to virgin materials, as well as challenges related to odor and appearance contamination. Furthermore, the inherent limitations of polyolefin-based resins necessitate the careful selection of additives, such as impact modifiers and stiffness enhancers, to achieve the desired performance characteristics. Thus, there is a need to improve the properties of recycled polyolefin-based resins to match those of virgin materials, thereby promoting sustainability without compromising quality.

### SUMMARY

The compositions disclosed herein solve the above-described problems by offering an innovative exterior material formulation specifically designed for automotive applications, including but not limited to automotive exterior components. In embodiments, the present disclosure provides an exterior material composition for an automotive application, optionally including automotive exterior parts, and an automotive material, which are eco-friendly and may secure properties and moldability at the level of virgin materials by using recycled polyolefin resin.

In embodiments, the present disclosure provides an exterior material composition for an automotive application comprising 25 to 95 parts by weight of a polyolefin-based recycled resin, 0 to 65 parts by weight of a high-density polyethylene (HDPE) resin, 5 to 30 parts by weight of an impact modifier, and 0 to 15 parts by weight of a filler.

In embodiments, the present disclosure provides automotive exterior parts comprising the exterior material composition for the automotive according to various embodiments of the present disclosure.

In embodiments, the present disclosure provides a automotive material comprising the automotive exterior parts according to various embodiments of the present disclosure.

In embodiments, the exterior material composition for the automotive is eco-friendly by comprising recycled materials, and in some embodiments, the exterior material composition effectively responds to environmental laws and regulations.

In embodiments, the exterior material composition for the automotive secures properties and moldability at the level of virgin materials while comprising recycled materials.

In embodiments, the automotive exterior parts comprising the exterior material composition for the automotive has a higher impact resistance than the related art.

In embodiments, the automotive exterior parts has excellent elongation and impact strength.

In embodiments, the automotive exterior parts comprising the exterior material composition for the automotive secures dimensional stability of about 7/1000, which is half the level of the related art. Accordingly, deformation after injection is reduced and stability is improved.

### DETAILED DESCRIPTION

All terms used herein including technical or scientific terms have the same meanings as generally understood by those skilled in the art unless otherwise defined. Terms defined in generally used dictionary shall be construed to have meanings matching those in the context of a related art, and shall not be construed in ideal or excessively formal meanings unless otherwise clearly defined herein.

As used herein, the terms including first, second, and the like is used for describing various components, but the components are not limited by the terms. These terms are only used to distinguish one component from another component. For example, without departing from the scope of the present disclosure, a first component is named as a second component, and similarly, a second component is named as a first component.

The terms used herein are used for describing particular embodiments only and are not intended to limit the present disclosure. A singular expression includes a plural expression unless otherwise defined differently in a context. In the present application, it should be understood that the term “including” or “having” or “comprising” indicates that a feature, a number, a step, an operation, a component, a part or a combination thereof described in the specification is present, but does not exclude a possibility of presence or addition of one or more other features, numbers, steps, operations, components, parts or combinations thereof, in advance.

In embodiments, an exterior material composition for an automotive of the present disclosure comprises a polyolefin-based recycled resin, high-density polyethylene (HDPE), an impact modifier, and a filler.

In embodiments, the polyolefin-based recycled resin is extracted from, for example, post consumer recycled (PCR) plastics, post industrial recycled (PIR) plastics, and end-of-life vehicles (ELV) recycled plastics. However, the polyolefin-based recycled resin is not limited thereto, and any recycled plastic generated in various industrial fields other than virgin materials is used without limitation.

In one example, the polyolefin-based recycled resin is post consumer recycled (PCR) plastics. In embodiments, the impact strength is excellent.

In embodiments, the polyolefin-based recycled resin comprises polyethylene. In embodiments, the polyethylene has relatively better dimensional stability than polypropylene. In embodiments, the polyethylene is applied to large and long exterior parts used in automotives.

In various embodiments of the present disclosure, the polyolefin-based recycled resin comprises at least one selected from the group of a first recycled polyethylene copolymer and a second recycled polyethylene copolymer.

In embodiments, the first recycled polyethylene copolymer has a melt index (MI) of 0.1 to 20 g/10 min (230° C., 2.16 kgf). In embodiments, the MI is 0.5 g/10 min (230° C., 2.16 kgf).

In embodiments, the second recycled polyethylene copolymer has a melt index (MI) of 20 to 100 g/10 min (230° C., 2.16 kgf). In embodiments, the MI is 30 g/10 min (230° C., 2.16 kgf).

In embodiments, the first recycled polyethylene copolymer has a higher viscosity than the second recycled polyethylene copolymer. At this time, the polyolefin-based recycled resin has a specific gravity of 0.85 to 1.25.

In embodiments, the first recycled polyethylene copolymer and the second recycled polyethylene copolymer comprise any one selected from the group of linear low density polyethylene (LLDPE), low density polyethylene (LDPE), and high density polyethylene (HDPE). In embodiments, the HDPE is included. When the HDPE is included, the property stability is improved.

Meanwhile, in various embodiments of the present disclosure, the polyolefin-based recycled resin is included in an amount of 25 to 95 parts by weight. At this time, the polyolefin-based recycled resin is included in 50% or more based on wt % in the exterior material composition for the automotive. Accordingly, the polyolefin-based recycled resin is eco-friendly compared to conventional exterior material compositions for automotives and may efficiently respond to environmental laws and regulations.

The exterior material composition for the automotive of the present disclosure may comprise a high-density polyethylene (HDPE) resin.

In the present disclosure, the HDPE is a virgin high-density polyethylene copolymer. In embodiments, the HDPE has a melt index (MI) of 20 to 100 g/10 min (230° C., 2.16 kgf). In embodiments, the MI is 30 g/10 min (230° C., 2.16 kgf).

In various embodiments of the present disclosure, the HDPE resin is included in an amount of 0 to 65 parts by weight.

In embodiments, the exterior material composition for the automotive of the present disclosure comprises an impact modifier. The polyolefin-based recycled resin of the exterior material composition for the automotive according to the present disclosure has a unique shrinkage rate. In embodiments, in order to prevent the unique shrinkage rate, the exterior material composition for the automotive according to the present disclosure comprises an impact modifier having high dimensional stability and excellent low-temperature characteristics to improve the properties.

In embodiments, the impact modifier comprises at least any one selected from the group of polyolefin elastomer (POE), polyolefin plastomer (POP), ethylene-octene rubber (EOR), ethylene-butene rubber (EBR), styrene-ethylene/butylene-styrene (SEBS), ethylene propylene monomer (EPM), ethylene propylene diene monomer (EPDM), and combinations thereof.

In one example, the impact modifier is an ethylene-alpha olefin copolymer. In embodiments, the ethylene-alpha olefin copolymer is amorphous. In another example, the ethylene-alpha olefin copolymer is in the form of a pellet or sheet. When the ethylene-alpha olefin copolymer is in the form of the pellet, the length thereof is 0.1 to 10 mm, and the thickness thereof is 0.1 to 2 mm.

In various embodiments of the present disclosure, the impact modifier is included in an amount of 5 to 30 parts by weight.

In embodiments, the exterior material composition for the automotive of the present disclosure comprises a filler. In embodiments, the filler reinforces the rigidity of the exterior material composition for the automotive according to the present disclosure. In addition, together with the impact modifier described above, the filler in some embodiments prevents a unique shrinkage rate in the polyolefin-based recycled resin, thereby improving the properties.

In embodiments, the filler comprises at least any one selected from the group of talc, calcium carbonate, mica, sodium salt, clay, whiskers, and combinations thereof. In one example, the filler is talc. At this time, the talc has a diameter of 0.1 to 10 μm. In addition, the color is 0 to 100 based on the L value.

In various embodiments of the present disclosure, the filler is included in an amount of 0 to 15 parts by weight.

In embodiments, the exterior material composition for the automotive of the present disclosure further comprises an additive. In the case of the exterior material composition for the automotive comprising the polyolefin-based resin, cracks or oxidation may occur depending on the amount of light of the irradiance. Therefore, in embodiments, in order to prevent the cracks or oxidation, the additive is used to protect against external environmental stimuli and secure the properties. In embodiments, the additive comprises an antioxidant, a heat-resistant stabilizer, a light-resistant stabilizer, a lubricant, an antistatic agent, etc. However, the additive is not limited thereto, and may use any common material that is added to the exterior material composition for the automotive of the present disclosure to improve the properties.

In embodiments, the exterior material composition for the automotive of the present disclosure further comprises a pigment. The pigment is added to the exterior material composition for the automotive according to the present disclosure to realize a desired color during injection. The pigment is any one selected from the group of AlO₃, carbon black, TiO₂, chrome antimony titanium buff rutile, FeO, H₄MnNO₇P₂, and combinations thereof. However, the pigment is not limited thereto, and may use any material that is added to the exterior material composition for the automotive according to the present disclosure to express a color.

In embodiments, automotive exterior parts of the present disclosure comprise the exterior material composition for the automotive according to various embodiments of the present disclosure described above. The automotive exterior parts is, for example, a bumper lip, a rocker panel, a wheel deflector, or a wheel strake, but are not limited thereto.

In embodiments, the automotive exterior parts of the present disclosure comprise the exterior material composition for the automotive according to various embodiments of the present disclosure described above to realize the properties and moldability at the level of virgin materials. In one example, when the automotive exterior parts comprise a polyolefin-based PCR recycled resin and high-density polyethylene, the automotive exterior parts has high impact strength and excellent properties.

In embodiments, the automotive exterior parts according to an embodiment of the present disclosure has elongation of 480 to 520%. The elongation is measured through a tensile test. In the present disclosure, the elongation is a value measured according to the ISO 527-1 test standard.

In embodiments, the automotive exterior parts according to the present disclosure has excellent elongation to have excellent processing and moldability and improve durability. Therefore, the automotive to which the automotive exterior parts are applied has excellent resistance to external impact.

In embodiments, the automotive exterior parts according to an embodiment of the present disclosure has IZOD impact strength of 5 to 85 KJ/m². Preferably, the IZOD impact strength is 50 to 85 KJ/m². The IZOD impact strength is measured by performing a pendulum-type impact test on a sample. The measured IZOD impact strength represents a value obtained by dividing the absorbed energy of the sample by the cross-sectional area of a groove portion of the sample. In the present disclosure, the IZOD impact strength is a value measured according to the ISO 180 test standard.

The automotive exterior parts of the present disclosure have excellent impact strength to improve safety. Therefore, the automotive to which the automotive exterior parts are applied has excellent resistance to external impact.

In embodiments, an automotive of the present disclosure comprises the automotive exterior parts according to various embodiments described above. Since the elongation, impact strength, etc. of the automotive exterior parts are excellent, the automotive according to the present disclosure has excellent mechanical properties.

Hereinafter, the present disclosure will be described in more detail with reference to Examples. However, the following Examples and Experimental Examples are only intended to describe the present disclosure in more detail, and the scope of the present disclosure is not limited by the following Examples and Experimental Examples.

### EXAMPLES

Examples having compositions of Table 1 below were prepared. Specific compositions of parts according to Examples 1 to 16 were as follows.

A high-viscosity and high-density polyethylene copolymer (melt index MI of 0.5 g/10 min (230° C., 2.16 kgf)) extracted from PCR was used as a first recycled polyethylene copolymer. The first recycled polyethylene copolymer was referred to as “First” in Tables 1 and 2 below.

A low-viscosity and high-density polyethylene copolymer (melt index MI of 30 g/10 min (230° C., 2.16 kgf)) extracted from PCR was used as a second recycled polyethylene copolymer. The second recycled polyethylene copolymer was referred to as “Second” in Tables 1 and 2 below.

A low-viscosity and high-density virgin polyethylene copolymer (melt index MI of 30 g/10 min (230° C., 2.16 kgf)) was used as a High-density polyethylene (HDPE).

Ethylene-alpha olefin copolymer was used as an impact modifier.

Talc was used as a filler.

An antioxidant, a heat-resistant stabilizer, a light-resistant stabilizer, a lubricant, and an antistatic agent were used as additive.

TABLE 1

| | Example No. | | | | | | | | | | | | | | | |
|---|---|---|---|---|---|---|---|---|---|---|---|---|---|---|---|---|
| Composition | 1 | 2 | 3 | 4 | 5 | 6 | 7 | 8 | 9 | 10 | 11 | 12 | 13 | 14 | 15 | 16 |
| First | 91 | 25 | — | 30 | 30 | 30 | 30 | 30 | 30 | 30 | 30 | 30 | 30 | 30 | 28 | 25 |
| Second | — | 63.3 | 30 | — | — | — | — | — | — | 15 | 30 | 43 | 27 | 25 | 25 | 25 |
| HDPE | — | — | 58.3 | 58.3 | 63 | 58 | 53 | 48 | 43 | 28 | 13 | — | 13 | 13 | 13 | 13 |
| Impact modifier | 7 | 10 | 10 | 10 | 5 | 10 | 15 | 20 | 25 | 25 | 25 | 25 | 25 | 25 | 25 | 25 |
| Filler | — | — | — | — | — | — | — | — | — | — | — | — | 3 | 5 | 7 | 10 |
| Additive | 1 | 1 | 1 | 1 | 1 | 1 | 1 | 1 | 1 | 1 | 1 | 1 | 1 | 1 | 1 | 1 |
| Pigment | 1 | 1 | 1 | 1 | 1 | 1 | 1 | 1 | 1 | 1 | 1 | 1 | 1 | 1 | 1 | 1 |

### Comparative Examples

Comparative Examples having compositions of Table 2 below were prepared.

Meanwhile, in Comparative Examples, unlike Examples, virgin polyethylene (PE) and virgin polypropylene (PP) were used as main resins, and the specific compositions of parts according to Comparative Examples 1 to 4 were as follows.

A low-viscosity polyethylene copolymer (melt index MI of 30 g/10 min (230° C., 2.16 kgf)) was used as the virgin polyethylene (PE).

A low-viscosity polypropylene copolymer (melt index MI of 100 g/10 min (230° C., 2.16 kgf)) was used as the virgin polypropylene (PP).

Ethylene octene rubber (melt index MI of 10 g/10 min (230° C., 2.16 kgf)) was used as an impact modifier.

Talc was used as a filler.

An antioxidant, a heat-resistant stabilizer, a light-resistant stabilizer, a lubricant, and an antistatic agent were used as additive.

TABLE 2

| | Comparative | Comparative | Comparative | Comparative |
|---|---|---|---|---|
| Composition | Example 1 | Example 2 | Example 3 | Example 4 |
| First | — | — | — | — |
| Second | — | — | — | — |
| PE | 80 | 80 | 50 | 80 |
| PP | 20 | 10 | 40 | 10 |
| Impact | — | 4 | 5 | 4.5 |
| modifier | | | | |
| Filler | — | 4 | 3 | 3.5 |
| Additive | — | 1.5 | 1.5 | 1.5 |
| Pigment | — | 0.5 | 0.5 | 0.5 |

### Experimental Example

The properties of the parts according to Examples 1 to 16 and Comparative Examples 1 to 4 were evaluated. First, the melt index (MI) of the parts was measured under conditions of a temperature of 230° C. and a stress load of 21.2 N, and the specific gravity was measured. In addition, the elongation and tensile strength (TYPE 1, speed of 50 mm/min) were measured, and the IZOD impact strength was measured under 23° C. conditions. In addition, a heat distortion temperature (HDT) was measured under a stress load condition of 0.45 MPa, and the hardness (Shore D) was measured.

Each evaluation follows the tests below.

1) Melt index MI (g/10 min): ISO 1133, 2) Specific gravity (g/cm³): ISO 1183, 3) Elongation (%) and tensile strength (MPa): ISO 527-1, 4) IZOD impact strength (KJ/m²): ISO 180, 5) Heat distortion temperature HDT (° C.): ISO 75, 6) Hardness (Shore D): ISO 868

The results for Examples 1 to 16 were shown in Table 3 below, and the results for Comparative Examples 1 to 4 were shown in Table 4 below. (Units were omitted.)

TABLE 3

| | Example No. | | | | | | | | |
|---|---|---|---|---|---|---|---|---|---|
| Properties | 1 | 2 | 3 | 4 | 5 | 6 | 7 | 8 | 9 |
| MI | 1.7 | 10 | 38 | 21 | 17 | 21 | 23 | 27 | 25 |
| Specific gravity | 0.94 | 0.95 | 0.95 | 0.95 | 0.95 | 0.95 | 0.94 | 0.941 | 0.941 |
| Elongation | 500 | 500 | 500 | 500 | 500 | 500 | 500 | 500 | 500 |
| Tensile strength | 20 | 19 | 20 | 20 | 23 | 20 | 19 | 18 | 13 |
| IZOD impact | 82.8 | 56 | 8.8 | 32 | 21 | 32 | 42 | 53 | 68 |
| strength | | | | | | | | | |
| HDT | 52 | 71 | 82 | 75 | 82 | 75 | 72 | 68 | 64 |
| Hardness | 58 | 56 | 54 | 57 | 60 | 57 | 53 | 50 | 52 |

| | Example No. | | | | | | |
|---|---|---|---|---|---|---|---|
| Properties | 10 | 11 | 12 | 13 | 14 | 15 | 16 |
| MI | 19 | 10 | 5.5 | 10 | 9.5 | 9.3 | 9.8 |
| Specific gravity | 0.941 | 0.94 | 0.941 | 0.96 | 0.98 | 1.00 | 1.01 |
| Elongation | 500 | 500 | 500 | 500 | 500 | 500 | 500 |
| Tensile strength | 15 | 16 | 17 | 15 | 15 | 14.5 | 14.0 |
| IZOD impact | 75 | 76 | 80 | 74 | 68 | 67 | 62 |
| strength | | | | | | | |
| HDT | 63 | 63 | 62 | 63 | 63 | 64 | 66 |
| Hardness | 52 | 52 | 51 | 52 | 51 | 51 | 50 |

TABLE 4

| | Comparative | Comparative | Comparative | Comparative |
|---|---|---|---|---|
| Properties | Example 1 | Example 2 | Example 3 | Example 4 |
| MI | 35 | 32 | 59 | 40 |
| Specific | 0.95 | 0.98 | 0.98 | 0.96 |
| gravity | | | | |
| Elongation | 300 | 500 | 350 | 400 |
| Tensile | 27 | 28 | 31 | 28 |
| strength | | | | |
| IZOD impact | 14 | 39 | 17 | 58 |
| strength | | | | |
| HDT | 85 | 90 | 85 | 98 |
| Hardness | 60 | 65 | 80 | 60 |

Referring to Tables 3 and 4, the parts of Examples and Comparative Examples were compared as follows.

When checking the melt index MI and specific gravity, it can be seen that the viscosity of the parts of Examples was relatively lower than that of Comparative Examples. In addition, with respect to the specific gravity, it can be seen that the values of the parts of Examples except for Examples 15 and 16 were similar to or lower than those of the parts of Comparative Examples. However, when referring to the properties of the parts of Examples 2 to 10, a difference in melt index was not large, and through this, it can be expected that the parts of Examples may secure the properties like the parts of Comparative Examples in terms of fluidity. In the case of the specific gravity, the difference was about 0.3, and it can be expected that the parts of Examples may secure the properties like the parts of Comparative Examples using virgin materials in terms of rigidity. In addition, it is suggested that the parts of Examples is selected in fields where weight reduction is rather important.

Meanwhile, when checking the tensile strength, heat distortion temperature, and hardness, it can be seen that the parts of Examples did not secure the properties like the parts of Comparative Examples. However, it can be seen that the parts of Examples had excellent durability due to elongation of 500%, and it can be seen that the impact strength was also excellent, so that safety has been improved. Through this, it is suggested that the parts of Examples have excellent flexibility compared to the parts of Comparative Examples, and thus have better resistance to external impact, and is used for parts requiring high impact strength.

In addition, the dimensional stability of the parts according to Examples 1 to 16 and Comparative Examples 1 to 4 was compared and analyzed. In the case of the dimensional stability, the parts of Examples and Comparative Examples were prepared as standard specimens with a GRID length of 130 mm based on 3.2 t, and then the specimens were left in a constant temperature and humidity room at 23° C., 1 atm, and 50±5% humidity for 48 hours, and then the shrinkage rate was measured. Finally, the dimensional stability was calculated by (GRID length (130 mm)—GRID length after left for 48 hours)/GRID length (130 mm)×1000. The average values of the dimensional stability of the parts of Examples 1 to 16 and the parts of Comparative Examples 1 to 4 were calculated as 7/1000 and 14/1000, respectively. It was confirmed that the dimensional stability of Examples was nearly half that of Comparative Examples, and through this, it can be determined that Examples have excellent stability against deformation after injection.

Herein above, the present disclosure has been described with reference to preferred embodiments thereof. It will be understood to those skilled in the art that the present disclosure is implemented as modified forms without departing from an essential characteristic of the present disclosure. Therefore, the disclosed embodiments should be considered in an illustrative viewpoint rather than a restrictive viewpoint. The scope of the present disclosure is illustrated by the appended claims rather than by the foregoing description, and all differences within the scope of equivalents thereof should be construed as being included in the present disclosure.

1. An exterior material composition for an automotive application comprising:
25 to 95 parts by weight of a polyolefin-based recycled resin;
0 to 65 parts by weight of a high-density polyethylene (HDPE) resin;
5 to 30 parts by weight of an impact modifier; and
0 to 15 parts by weight of a filler.

2. The exterior material composition for the automotive of claim 1, wherein the polyolefin-based recycled resin comprises at least any one selected from the group consisting of a first recycled polyethylene copolymer and a second recycled polyethylene copolymer,
the first recycled polyethylene copolymer has a melt index of 0.1 to 20 g/10 min (230° C., 2.16 kgf), and
the second recycled polyethylene copolymer has a melt index of 20 to 100 g/10 min (230° C., 2.16 kgf).

3. The exterior material composition for the automotive of claim 1, wherein the high-density polyethylene (HDPE) resin is a virgin high-density polyethylene copolymer.

4. The exterior material composition for the automotive of claim 1, wherein the polyolefin-based recycled resin has specific gravity of 0.85 to 1.25.

5. The exterior material composition for the automotive of claim 1, wherein the impact modifier comprises any one selected from the group consisting of polyolefin elastomer (POE), polyolefin plastomer (POP), ethylene-octene rubber (EOR), ethylene-butene rubber (EBR), styrene-ethylene/butylene-styrene (SEBS), ethylene propylene monomer (EPM), ethylene propylene diene monomer (EPDM), and combinations thereof.

6. The exterior material composition for the automotive of claim 1, wherein the impact modifier is an ethylene-alpha olefin copolymer, and is in a form of a pellet having a length of 0.1 to 10 mm and a thickness of 0.1 to 2 mm.

7. The exterior material composition for the automotive of claim 1, wherein the filler comprises at least any one selected from the group consisting of talc, calcium carbonate, mica, sodium salt, clay, whiskers, and combinations thereof.

8. The exterior material composition for the automotive of claim 1, wherein the filler is talc, and has a diameter of 0.1 to 10 μm.

9. Automotive exterior parts comprising the exterior material composition for the automotive according to claim 1.

10. The automotive exterior parts of claim 9, wherein the automotive exterior parts have elongation of 480 to 520%.

11. The automotive exterior parts of claim 9, wherein the automotive exterior parts have IZOD impact strength of 50 to 85 KJ/m².

12. An automotive comprising the automotive exterior parts according to claim 9.
